(19) United States
(12) Patent Application Publication
(10) Pub. No.: US 2003/0030527 A1
(43) Pub. Date: Feb. 13, 2003

(54) Microelectromechanical component

(75) Inventors: Ahmed Mhani, Grenoble (FR); Jean-Marc Fedeli, Saint Egreve (FR)

Correspondence Address: HESLIN ROTHENBERG FARLEY & MESITI PC, 5 COLUMBIA CIRCLE, ALBANY, NY, 12203, US

(73) Assignee: MEMSCAP Parc Technologique des Fontaines, Crolles (FR)

(21) Appl. No.: 10/213,928

(22) Filed: Aug. 6, 2002

(30) Foreign Application Priority Data
Aug. 6, 2001 (FR) 01 10495

(51) Int. Cl. H01F 21/06

(52) U.S. Cl. 336/130

(57) ABSTRACT

A microelectromechanical component (1) providing filtering functions, produced on a semiconductor-based substrate (10) and comprising two input terminals (7, 8) and two output terminals (26, 27), which also comprises:

a metal input coil (2), connected to the input coils (7, 8) and capable of producing a magnetic field when a current flows through it;

a movable element (3), connected to the substrate by at least one deformable portion and including at least one region (11, 12) made of a ferromagnetic material, said movable element (3) being capable of moving under the effect of the force, to which the region (11) made of a ferromagnetic material is subject, generated by the magnetic field produced by the input coil (2);

an output member (4) forming a magnetic sensor, connected to the output terminals (26, 27) and capable of producing an electrical signal that can be varied according to the movement of the movable element (3).

### TECHNICAL FIELD

The invention relates to the field of microelectronics, and more precisely to that of components used in radiofrequency ranges. More specifically, it provides a novel structure, for passive filters used in electronic circuits, made from microelectromechanical systems known by the name “MEMS”.

### PRIOR ART

In the telecommunications field, various types of filter are used to carry out filtering functions, especially in stages operating at intermediate frequency, or in oscillators, or else in other types of function.

Of the various filters used, mention may especially be made of quartz filters, and surface acoustic wave filters, also known by the abbreviation “SAW”. This type of filter operates by making use piezoelectric phenomena. They are valued for their high quality factor and excellent stability, especially of the resonant frequency, with regard to temperature and aging. However, because of technological limitations, the number of poles of such a filter cannot be very significantly increased. These same technological constraints make this type of filter very difficult to miniaturize to any great extent.

It has also been proposed to produce filters using MEMS technologies which operate on the basis of electrostatic phenomena.

Thus, in general, such a filter uses two plates operating as a capacitor. The application of an AC voltage which depends on the input signal at the terminals of this capacitor causes a movement of the plate, which is movable, and therefore a variation in the capacitance of the capacitor, and consequently variation in an output signal. The two plates are movable one with respect to the other, and part of the system acts as a return member in order to oppose the deformation generated by the variation in the input signal. The natural frequency of this filter depends on the geometry of the structure, and on the bias voltage applied between the plates.

Several geometries have already been envisaged for filters operating on the basis of electrostatic phenomena.

Thus there are filters, or more generally resonators, in which the movable plate moves perpendicular to the main plane of the substrate on which the microcomponent is produced. Some of these resonators may also be coupled to each other to improve performance. One of the drawbacks of this type of resonator is some sensitivity to pressure variations, which require encapsulation of the microcomponents under a vacuum or under very low pressure.

Another drawback is that of needing a bias voltage which may be relatively high, greater than ten volts, in order to obtain the desired performance.

Moreover, other filters are known which operate on the basis of electrostatic phenomena and in which the movable plate moves in a plane parallel to the main plane of the substrate on which the microcomponent is produced. The same goes for filters whose plates are formed by interdigitated combs. By virtue of this configuration, the surface areas opposite the other plates are relatively large, which makes it possible to obtain enough travel with bias voltages which are lower than for the solutions described above.

However, these solutions have certain limitations. This is because the natural frequency of such a resonator depends on the stiffness constant of the return means inserted between the plates and on the mass of the movable plate. Thus, in order to achieve high resonant frequencies, it will be preferable to increase the stiffness constant while decreasing the mass of the movable plate. However, the use of a high stiffness constant results in a low amplitude of movement of the movable plate, which is not always enough to distinguish the generated signal correctly from the noise. A compromise therefore remains to be made between increasing the frequency of the filter and the amplitude of the output signal.

A first problem which the invention therefore proposes to solve is that of increasing the resonant frequencies of filters produced using MEMS technologies. Another problem which the invention proposes to solve is that of the need to produce vacuum packagings in order to preserve good filter stability and a high resonant frequency.

Another problem is that of the compatibility between increasing the resonant frequency and the output signal level, observed on filters made using MEMS technology and operating on the basis of electrostatic phenomena. Another problem that the invention seeks to solve is that of using high bias voltages which generate relatively high consumption, to the detriment of autonomy, and induce insulation stresses.

### SUMMARY OF THE INVENTION

The invention therefore relates to a microelectromechanical component providing filtering functions, produced on a semiconductor-based substrate and comprising two input terminals and two output terminals.

According to the invention, this microcomponent also comprises:

a metal input coil, connected to the input terminals, capable of producing a magnetic field when a current flows through it;

a movable element, connected to the substrate by at least one deformable portion and including at least one region made of a ferromagnetic material, said movable element being capable of moving under the effect of the force, to which the region made of ferromagnetic material is subject, generated by the magnetic field produced by the input coil;

an output member forming a magnetic sensor, connected to the output terminals and capable of producing an electrical signal that can be varied according to the movement of the movable element.

In other words, the filter comprises a movable part which is made to move under the action of the magnetic field produced by the input coil. The electrical energy of the input signal is therefore converted into mechanical energy by the characteristic movable element. This movable element excites a magnetic sensor which produces an electrical output signal, resulting from the movement of the movable element. The mechanical energy of the movable element is therefore converted into electrical energy by the sensor forming the output step of the filter.

By converting electrical energy into magnetic energy and vice versa, the sensitivity of the filter to higher frequencies is improved in comparison with filters operating on electrostatic principles. This is because the resonant frequency is increased by choosing a high ratio of the stiffness of the return means to the mass of the movable element. Although the amplitudes of the mechanical oscillations are relatively small, a signal generated at the output stage, which is large enough to be usable, is, however, obtained.

Given the high sensitivity of the magnetic sensors used, in comparison with electrostatic sensors, it is not absolutely necessary for the microcomponent to be encapsulated under a vacuum, rather it may on the contrary operate at atmospheric pressure, which simplifies the fabrication method and therefore decreases the corresponding cost.

Various architectures can be employed to produce the input stage, the movable element and the output stage of the component of the invention.

Thus, the metal coil forming the input of the filter can be made in the form of a solenoid. In this case, it involves a winding around an axis which is generally parallel to the main plane of the substrate on which the filter is produced. The magnetic field produced by this input coil is therefore parallel to the plane of this substrate, and therefore induces a movement of the movable element parallel to this same plane.

In another embodiment, the coil physically embodying the input may be produced by a flat spiral winding. In this case, the coil may be parallel to the main plane of the substrate, and it produces a magnetic field which is perpendicular to this same plane. It then induces a magnetic field, with field lines contained in planes perpendicular to the main plane of the substrate. Depending on the position of the movable element, the latter may be moved perpendicular to the main plane of the substrate.

More generally, the movable element can be connected to the substrate by a single deformable portion or else by two deformable portions located on either side of the movable element. The shape and the dimensions of its deformable portions are determined so that the return means have optimum stiffness, sufficient amplitude of movement and suitable solidity.

In practice, the movable element may comprise a region made of a soft ferromagnetic material, being magnetized under the effect of the magnetic field produced by the input coil.

In other embodiments, the movable element may comprise a region made of a hard ferromagnetic material, forming a permanent magnet.

In some embodiments, the movable element may compromise a single element made of a ferromagnetic material, which, on the one hand, is subject to the effect of the magnetic field produced by the input coil, and, on the other hand, induces a field which acts on the magnetic output sensor.

In other embodiments, the movable element may comprise two regions made of ferromagnetic materials, that is: a first region subject to the force generated by the magnetic field produced by the input coil, and a second region interacting with the output member.

This output member may be produced in different ways. Thus it may involve a metal coil connected to the output terminals. This coil may then, following the example of the input coil, be either of the solenoid type or of the flat spiral coil type.

In other embodiments, the output member is a magnetic sensor of the type chosen from the group comprising:

Hall effect sensors;

flux-gate magnetometers,

magnetoresistors;

magnetodiodes;

inductive sensors.

In practice, this component may be integrated into a filter with one or more poles, in combination with one or more components of the same type or of different types.

### BRIEF DESCRIPTION OF THE FIGURES

The manner of embodying the invention and the advantages which result therefrom will emerge clearly from the description of the following embodiments, with the support of the appended figures, in which:

FIG. 1 is a rough perspective view of a component according to the invention, produced according to a first embodiment.

FIG. 2 is a top view of the component of FIG. 1.

FIG. 3 is a rough perspective view of a microcomponent produced according to a second embodiment of the invention.

FIG. 4 is a top view of the microcomponent of FIG. 3.

FIG. 5 is a rough perspective view of a microcomponent produced according to a third embodiment.

FIG. 6 is a top view of the microcomponent of FIG. 5.

### MANNER OF EMBODYING THE INVENTION

As mentioned above, the invention relates to a microcomponent used as a filter or integrated into a filter with several poles. This microcomponent operates on the principle of the generation of magnetic energy from an electrical signal, then the conversion of this magnetic energy into kinetic energy by a movable element. This kinetic energy is in its turn converted into an electrical signal by phenomena of magnetic origin.

The invention can be implemented by employing various architectures that make it possible to obtain similar results and that operate on equivalent principles.

First Embodiment of the Invention

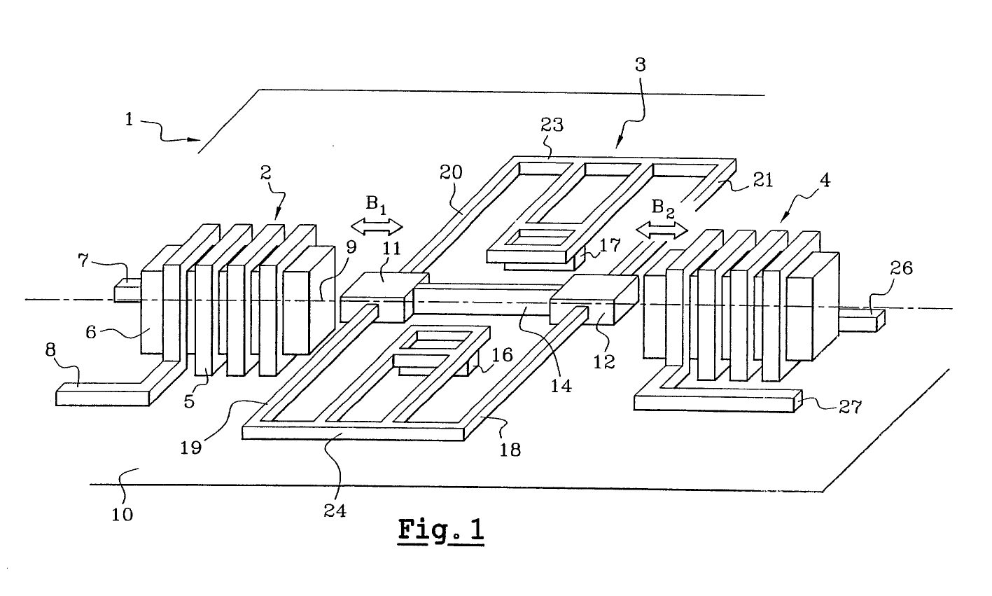

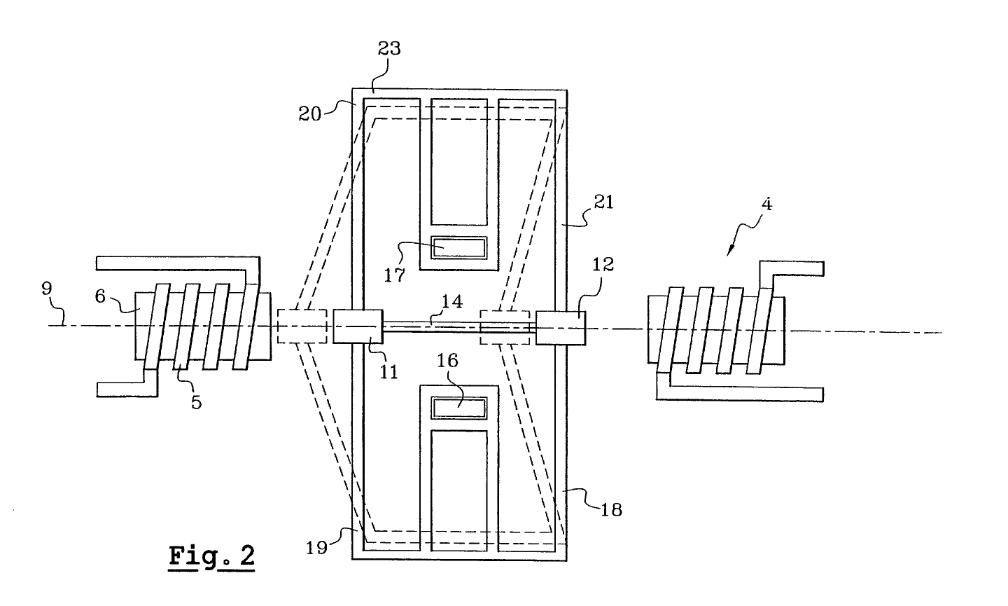

As illustrated in FIGS. 1 and 2, the microcomponent can be produced on a substrate based on semiconductors such as silicon.

This component (1) mainly comprises an input coil (2), a movable element (3) and an output coil (4). More specifically, the input coil is produced in the form of a solenoid by winding several metal turns (5) around a core (6) made of a ferromagnetic material. These metal turns (5) and the corresponding core (6) may, for example, be produced according to the method described in document EP 1 054 417 of the applicant. They may however be produced according to a different method. This solenoid (2) therefore comprises several turns (5) wound around a ferromagnetic coil (6), which makes it possible to produce a magnetic field (B₁) oriented along the axis of the solenoid (9) and parallel to the main plane of the substrate (10) by passing current between the input terminals (7, 8).

The movable element (3) characteristic of the invention is placed along the axis (9) of the input solenoid (2) and, in the form illustrated, comprises two pads (11, 12) made of a ferromagnetic material. These two pads (11, 12) are separated by a longitudinal beam (14) made from the substrate, or by a metal coating. Each of the pads (11, 12) made of a ferromagnetic material is connected to a pad (16, 17), which is stationary with respect to the substrate (10), via various transverse and longitudinal beams. More specifically, and in the form illustrated, each ferromagnetic pad (11, 12) has, on each side, a transverse beam (18, 19, 20, 21) located on either side of the central longitudinal beam (4). Each transverse beam (18, 21) is connected to the beam (19, 20) located on the same side via a longitudinal link beam (23, 24). This longitudinal link beam (23, 24) is connected to the stationary pad (16, 17) via two transverse portions secured to the pad which is stationary with respect to the substrate (10).

Of course, other geometries and architectures can be envisaged for connecting the movable element and more specifically the ferromagnetic pads (11, 12) to the points (16, 17) which are stationary with respect to the substrate. Some examples will be described further on. The movable element (3) and, more specifically, the various beams (14, 18-21, 23, 24) joining the ferromagnetic pads (11, 12) to the points (16, 17) which are stationary with respect to the substrate, are made either from metal or from polysilicon.

The structure of the movable element (3) can be deformed in a longitudinal direction, that is to say parallel to the axis (9) of the input solenoid, by virtue of the ability of the various beams forming it, and especially of the transverse beams (18-21), to flex. The thickness of the beams is determined in order to increase as much as possible the stiffness measured perpendicular to the main plane of the substrate (10) and in a transverse direction. As such, the movement of the two pads (11, 12) made of a ferromagnetic material is almost exclusively directed along the longitudinal axis (9) of the input solenoid (2). FIG. 2 shows an example of movement of the central part of the movable element (3), between a rest position and an extreme position.

The two ferromagnetic pads (11, 12) located on the movable element (3) may have different magnetic properties. If these pads are made of a soft ferromagnetic material, the pads are subject to an attractive force. If the pads are made of a hard ferromagnetic material, they behave like a permanent magnet, with attractive and repulsive forces.

The two pads (11, 12) may be either identical in nature or different in nature, it being possible for the pad (11) located closer to the input coil (2) to be made either of a hard ferromagnetic material or of a soft ferromagnetic material.

The component according to the invention also comprises an output coil (4) located on the other side of the movable element (3) from the input coil (2). In the form illustrated in FIG. 1, the output coil has a structure similar to the input coil. This output (4) is connected to the output terminals (26, 27) of the filter, or else incorporated into the electrical circuit of a complementary filter, intended to form a more complex filter with multiple poles.

The device operates as follows: when an electric current flows through the input coil (2), it produces a magnetic field (B₁) which is directed along the longitudinal axis (9) of the input coil (2). This magnetic field (B₁) creates an electromagnetic force on the pad (11) made of a ferromagnetic material located on the movable element (3). This force depends on the type of material used for the ferromagnetic pad and on the geometry of the solenoid, on the material forming the core (9) of the solenoid, and on the geometry of the ferromagnetic pad (11). This force deforms the structure of beams (18-21) of the movable element (3), and therefore leads to movement of the movable element (3) along the longitudinal axis (9) of the solenoid.

The second pad (12) made of a ferromagnetic material, located close to the output coil (4), therefore moves along the longitudinal axis (9) of the output solenoid. If the pad (12) is made of a hard ferromagnetic material, and therefore forms a permanent magnet, movement of the pad (12) generates a variation in the flux of the magnetic field (B₂) produced by the pad (12), inside the output solenoid (4). This flux variation induces a back-electromotive force at the terminals (26, 27) of the output solenoid (4). This electrical signal therefore corresponds to the output of the filter when the component is used as a simple filter.

When the ferromagnetic pad (12) located close to the output solenoid (4) is made of a soft ferromagnetic material, its movement induces a modification in the magnetic circuit of the output solenoid (4), and therefore induces a modification in the value of the inductance of this solenoid. This variation is also an electrical signal which can be exploited by a suitable device.

Second Embodiment of the Invention

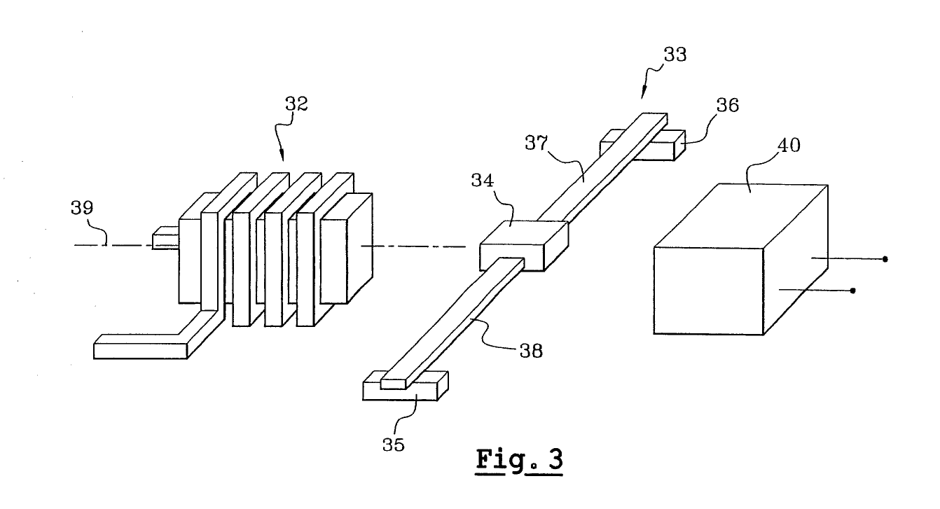

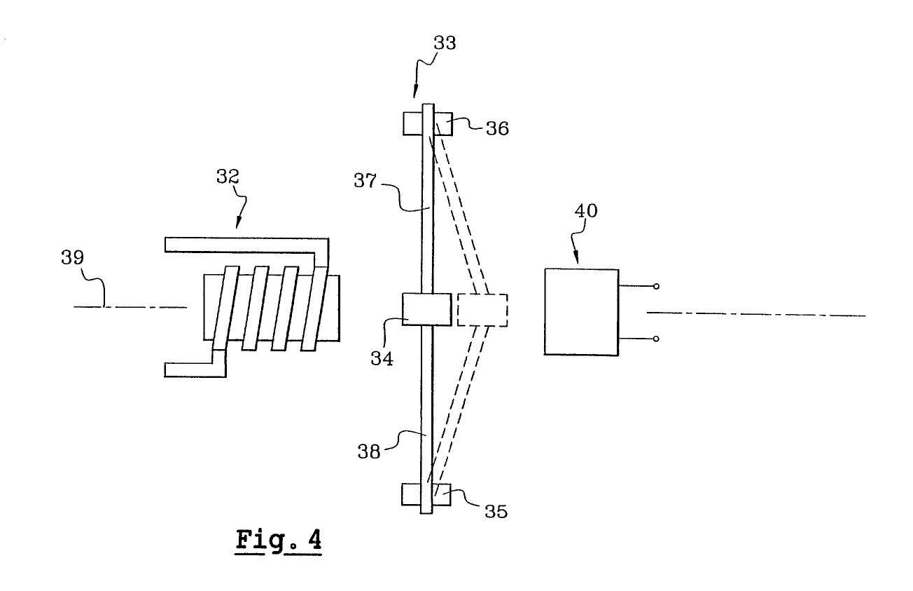

FIGS. 3 and 4 illustrate an alternative embodiment derived from the example described above. In this case, the input coil (32) is identical to that described in the previous example.

The movable element (33) consists of a single pad (34) made of a hard or soft ferromagnetic material. This ferromagnetic pad (34) is connected to two points (35, 36), which are stationary with respect to the substrate, via two transverse beams (37, 38).

The dimensions, that is to say the length and thicknesses and the width of the two beams (37, 38) are determined so that the stiffness is as small as possible along the longitudinal axis (39) of the input solenoid (32). In a particular form (not shown), the movable element may be connected to the substrate via a single transverse beam.

The output stage of the filter of FIGS. 3 and 4 may be produced by various types of magnetic sensor (40) that are sensitive to the movement of the ferromagnetic pads.

Third Embodiment of the Invention

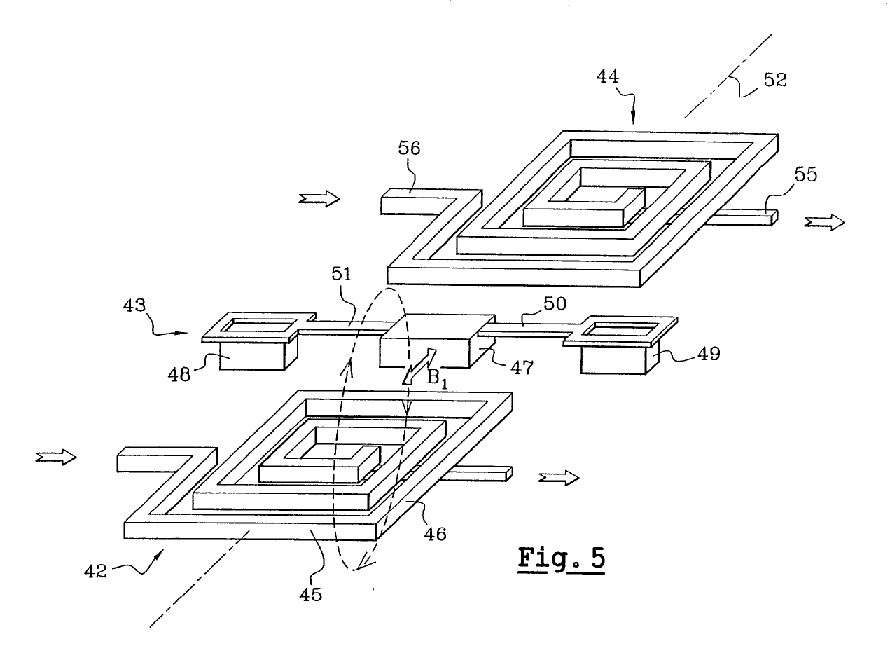

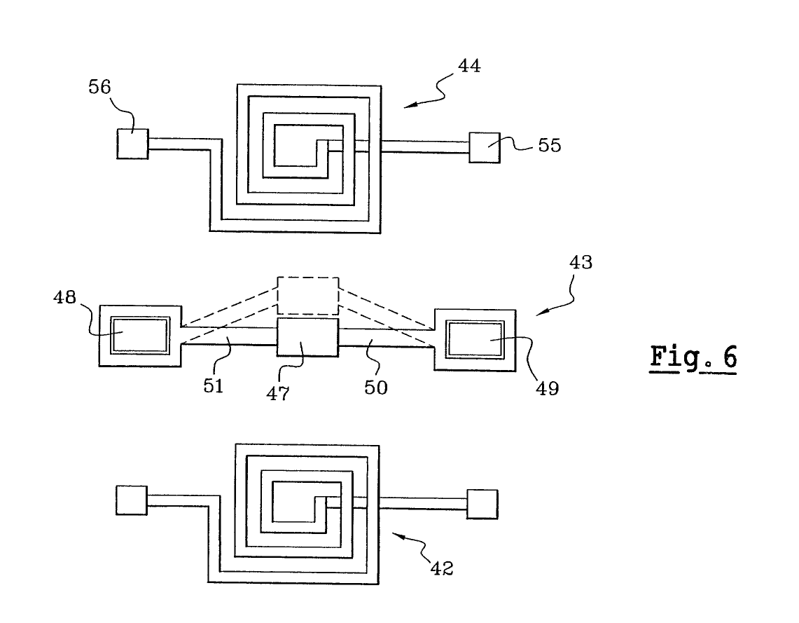

FIGS. 5 and 6 illustrate another embodiment of the invention in which the input and output coils are produced differently.

More specifically, the input coil (42) is made in the form of a flat spiral winding. This winding has several parallel and perpendicular segments (45, 46) which may be produced in particular according to the teachings of document EP 1 039 544 of the applicant. Nevertheless, such a spiral winding can also be obtained by different methods.

In this configuration, when a current flows through the input coil (42), it produces a magnetic field (B₁) which is perpendicular to the plane of the substrate (10) in the central part of the coil (42), and the field lines of which thereby cross the main plane of the substrate outside the coil.

The output coil (44) is made in the same way as the input coil (42), by a flat spiral winding located in the same plane as that of the input coil (42).

Between the input and output coils, the component comprises the characteristic movable element (43) which, in the form illustrated, comprises a pad (47) made of a ferromagnetic material connected to two points (48, 49) which are stationary with respect to the substrate, via two beams (50, 51).

More specifically, the magnetic pad (47) is located slightly above the plane formed by the two input (42) and the output (44) coils. As such, when a current flows through the input coil (42), a magnetic field is produced, illustrated by the arrow (B₁) of FIG. 5. This magnetic field, by interacting with the ferromagnetic pad (47), generates a force on this pad, one component of which is located in the main plane of the substrate (10) and, more specifically, is parallel to the direction (52) connecting the two centers of the flat coils (42, 44).

It follows that the ferromagnetic pad (47) moves parallel to the aforementioned direction (52), at the frequency of the current flowing through the input coil (42).

The geometry of the various beams (50, 51) connecting the ferromagnetic pad (47) to the stationary points (48, 49) is determined so that the stiffness is as great as possible in the direction perpendicular to the substrate (10) so that the ferromagnetic pad actually moves between the two flat coils (42, 44).

When the ferromagnetic pad (47) moves under the effect of the field produced by the input coil (42), it causes a variation in the flux of the magnetic field it produces inside the output coil (44). Subsequently, a back-electromotive force appears between the terminals (55, 56) of the output coil (44), which forms the filter for the input signal.

When the ferromagnetic pad is made of a soft ferromagnetic material, it also produces a variation in the inductance of the flat output coil (44), which can be exploited by a suitable device.

It emerges from the foregoing that the components according to the invention have many advantages, and especially that of preserving a high movement amplitude of the movable element, even at the high frequency range employed, which makes it possible to obtain an output signal of sufficient amplitude for satisfactory use.

1. A microelectromechanical component (1) providing filtering functions, produced on a semiconductor-based substrate (10) and comprising two input terminals (7, 8) and two output terminals (26, 27), which also comprises:
a metal input coil (2), connected to the input coils (7, 8) and capable of producing a magnetic field when a current flows through it;
a movable element (3), connected to the substrate by least one deformable portion and including at least one region (11, 12) made of a ferromagnetic material, said movable element (3) being capable of moving under the effect of the force, to which the region (11) made of a ferromagnetic material is subject, generated by the magnetic field produced by the input coil (2);
an output member (4) forming a magnetic sensor, connected to the output terminals (26, 27) and capable of producing an electrical signal that can be varied according to the movement of the movable element (3).

2. The component as claimed in claim 1, wherein the metal input coil (2) is of the solenoid type.

3. The component as claimed in claim 1, wherein the metal input coil (32) is of the flat spiral coil type.

4. The component as claimed in claim 1, wherein the movable element is connected to the substrate by a single deformable portion.

5. The component as claimed in claim 1, wherein the movable element (3) is connected to the substrate by two deformable portions (18-21, 23, 24) located on either side of the movable element.

6. The component as claimed in claim 1, wherein the movable element comprises a region (11, 12) made of a soft ferromagnetic material, which is magnetized under the effect of the magnetic field produced by the input coil.

7. The component as claimed in claim 2, wherein the movable element comprises a region (11, 12) made of a hard ferromagnetic material, forming a permanent magnet.

8. The component as claimed in claim 1, wherein the movable element comprises two regions made of a ferromagnetic material, that is:
a first region (11) subject to the force generated by the magnetic field produced by the input coil (2);
a second region (12) interacting with the output member (4).

9. The component as claimed in claim 1, wherein the output member (4) is a metal coil connected to the two output terminals.

10. The component as claimed in claims 2 and 9, wherein the metal output coil (4) is of the solenoid type.

11. The component as claimed in claims 3 and 9, wherein the metal output coil (44) is of the flat spiral coil type.

12. The component as claimed in claim 1, wherein the output member (40) is a magnetic sensor of the type chosen from the group comprising:
Hall effect sensors;
flux-gate magnetometers;
magnetoresistors;
magnetodiodes;
magneto-inductive sensors.
